(19) United States
(12) Patent Application Publication
(10) Pub. No.: US 2007/0278784 A1
(43) Pub. Date: Dec. 6, 2007

(54) Personalized fan certificate

(76) Inventor: John Alan Aragon, Lakewood, CO (US)

Correspondence Address: BARBER LEGAL, P.O. BOX 16220, GOLDEN, CO, 80402-6004, US

(21) Appl. No.: 11/804,051

(22) Filed: May 17, 2007

Related U.S. Application Data
(60) Provisional application No. 60/801,180, filed on May 17, 2006.

(51) Int. Cl. B42D 15/00

(52) U.S. Cl. 283/67

(57) ABSTRACT

A personalized fan certificate having a displayable sports/entertainment/event logo, a team/entertainer/event name, as well as a personalized fan name or affiliation printed on the certificate. The personalized fan certificate allows a fan to have an entertainer/team/event/season/ticket holder status/charity sponsored certification of loyalty, and includes on the certificate the selected logo, decal, or indica of the object of the loyalty, along with text that represents a particular sport, athlete, or entertainer. Each certificate may contain a gold seal with embossed text, and may be printed on certificate paper which in any size. The certificate may in addition contain logos or insignia of larger organizations to which the object of fan loyalty in turn belongs, such as logos of sports leagues, studios, event sponsors or the like.

### CROSS-REFERENCE TO RELATED APPLICATIONS

The application claims the priority and benefit of U.S. Provisional Patent Application No. 60/801,180 filed May 17, 2006 in the name of the same inventor, John Aragon, and entitled PERSONALIZED FAN CERTIFICATE, the entire disclosure of which in incorporated herein by this reference.

### COPYRIGHT AND TRADEMARK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

Certain trademarks are reproduced herein, these trademarks are the property of the National Football League, the National Hockey League, Major League Baseball, the National Basketball League, the Arena Football League, the NCAA, the Pepsi Center and other Venues, the National Lacrosse League, individual teams therein and various recording studios.

The present applicant does not claim rights to nor affiliations with the trademarks represented herein, which are presented merely as examples of trademarks. The present applicant does not offer any products or services bearing these marks and makes no claim whatsoever to any interest in these marks.

The present applicant uses these marks strictly in this government document and strictly to identify the products offered by the various mark owners, who are not affiliated with the applicant.

The applicant makes every effort to do the following: the proprietary nature of the marks is respected, and every effort is made to prevent their use in any manner which might adversely affect their validity as trademarks. United States Manual of Patent Examining Procedure,

### FIELD OF THE INVENTION

This invention relates generally to items of memorabilia and specifically to personalized memorabilia.

### STATEMENT REGARDING FEDERALLY FUNDED RESEARCH

This invention was not made under contract with an agency of the US Government, nor by any agency of the US Government.

### BACKGROUND OF THE INVENTION

Enthusiasts of various events, such as concerts, sporting events, entertainment events, and the like, often desire to retain a memento of the event. In addition, enthusiasts of such events often desire a displayable memento bearing various indicia relating to the specific event attended by the enthusiast or fan, such as a sports team logo, a band logo, an illustration or picture of an athlete, a league logo or assortment of league related marks or the like.

A fan does not have to do anything special besides have a liking for a particular sports team, athlete, entertainer, group or personality. Age, religion, sex, race, IQ, or anything that distinguishes between groups of people doesn't matter, because anyone can obtain a personalized sports fan certificate to represent their loyalty to their team, athlete, entertainer, group or personality.

Use of and licensing of team logos for fan identification is an enormous business in the United States and worldwide. The name and logo of a particular team, group, athlete, entertainer, etc may appear on such items as jackets, jerseys, tee shirts, and almost every item of clothing, pamphlets and booklets, and on other items of interest to the enthusiastic fan. Such items are very suitable for personal purchase or for birthday, anniversary and holiday-gift giving as a result of excellent multi-media marketing by leagues and individual teams. License plates and license plate holders, in addition to decals, often display a team of popularity and interest. The merchandising of collectable memorabilia and related products at entertainment events has developed into a sizable and profitable business. Various sporting events can sometimes generate attendance numbers over one hundred thousand. The large number of patrons that attend these various events provides a sizable target audience for advertising and merchandising efforts.

However, there is not known any “official” designation of true fan status. When a person graduates from high school or college he or she receives a certificate representing their accomplishments and symbolizing their pride, which certificate may often be found hanging up in their home or office. The applicant is unaware of any corresponding certification offered to die-hard fans of sporting events, teams, leagues or personalities, nor of entertainment events or personalities, allowing the individual enthusiast to certify their loyalty and/or support.

Certain references show other type of memorabilia articles of interest, which all differ from the invention described herein.

U.S. Pat. No. 6,920,709 issued Jul. 26, 2005, in the name La Malfa, teaches an article having a distance measurement from a first address, that of a fan, to a selected home plate of a baseball diamond. It lacks a “fan certification” feature.

U.S. Pat. No. 6,413,617 issued Jul. 2, 2002, in the name of Schlier teaches a card for retaining articles largely unrelated to fan loyalty.

U.S. Pat. No. 6,550,066 issued Apr. 22, 2003 to Brassey teaches a sports jacket which is reversible for displaying alternative or momentarily changing fan loyalties, and thus teaches away from a true fan certification.

U.S. Pat. No. 6,546,651 issued Apr. 15, 2003 to Tremonti teaches a ticket display device which may have indicia of a specific event thereon, however, it lacks any form of fan certification.

U.S. Pat. No. 6,082,774 issued Jul. 4, 2000 to Schlauch teaches an article with a facsimile of a fingerprint of a personality, a witness-signed authentication or other certification that the personality in fact signed, fingerprinted, etc the article, however, it lacks any certification of fan status of the fan owner, rather than the personality.

U.S. Pat. No. 6,532,345 issued Mar. 1, 2003 to Gluck teaches equipment for photographing fans at an event and selling the images.

U.S. Pat. No. 6,471,059 issued Oct. 29, 2002 to Purvis teaches a cooler with alternative logos on the removable top.

None of these devices teach a method for a fan to be “certified” as a fan of an athlete, event, entertainer, team or the like.

Thus it would be desirable to provide a certification identifying a particular individual as a fan or attendee of a given sport, league, team, athlete, entertainer, product, season, event, championship game, concert, slogan or the like.

It is also an object of the present invention to provide a ticket or ticket stub display device that is a displayable souvenir or keepsake.

It is a further object of the present invention to provide a ticket or ticket stub display device having various indicia related to the event printed or displayed thereon.

### SUMMARY OF THE INVENTION

General Summary

The present invention teaches an item of memorabilia which allows official certification of an individual as a fan of an object of fan loyalty, which personalized fan certificate may have a displayable sports/entertainment/event logo, a team/entertainer/event name, as well as a personalized fan name or affiliation printed on the certificate. Such objects and indicators of fan loyalty as fan or attendee of a given sport, league, team, athlete, entertainer, product, season, event, championship game, concert, slogan or the like all may be subject of the method. The official certification may take the form of a signature of an official authorized by the object of loyalty to make such certifications, or a seal or the like, and in addition the words “Certified (object of loyalty) Fan” or a similar indication, such as a slogan of fan support.

The personalized fan certificate allows a fan to have an entertainer/team/event sponsored certification of loyalty, and includes on the certificate the selected logo, decal, or indica of the object of the loyalty, along with text that represents a particular sport, athlete, or entertainer. The appearance of the certificate is that of any other certificate such as a diploma or the like, including borders, text, watermarks and the like as appropriate. The certificate may be numbered and dated and may provide the contact information of the certifying body.

Each certificate may contain a gold, silver or impressed seal with embossed text, and may be printed on certificate paper which in any size. The certificate may in addition contain logos or insignia of larger organizations to which the object of fan loyalty in turn belongs, such as logos of sports leagues, studios, event sponsors or the like.

In embodiments, the device of the invention may include means of display of a ticket stub from an event at which the object of loyalty may be seen and which the certified fan attended.

Summary in Reference to the Claims

It is therefore a first aspect, advantage, objective and embodiment of the present invention to provide an item of memorabilia comprising:
a first identification of at least one fan;
a second identification of a first object of fan loyalty;
an officially sanctioned certification of the status of the at least one fan as being a fan of the first object of fan loyalty; and
indicia of the importance of the certification to the fan and object of the fan loyalty.

It is therefore another aspect, advantage, objective and embodiment of the present invention to provide an item of memorabilia, wherein the first identification of the individual fan further comprises: the name of the individual fan

It is therefore another aspect, advantage, objective and embodiment of the present invention to provide an item of memorabilia, wherein the first object of fan loyalty further comprises: one member selected from the group consisting of: a sporting team, an individual athlete, an individual entertainer, a sporting event, an entertainment event, an athletic league, a athletic season, and combinations thereof.

It is therefore another aspect, advantage, objective and embodiment of the present invention to provide an item of memorabilia, wherein the first identification of the first object of fan loyalty further comprises: one member selected from the group consisting of: a logo of the first object of fan loyalty, a name of the first object of fan loyalty, an admission ticket to an event including the object of fan loyalty and combinations thereof.

It is therefore another aspect, advantage, objective and embodiment of the present invention to provide an item of memorabilia, wherein the officially sanctioned certification of status further comprises: a seal, a signature of an official connected with the object of the fan loyalty, and combinations thereof.

It is therefore another aspect, advantage, objective and embodiment of the present invention to provide an item of memorabilia, further comprising:

indicia of association with a charity organization.

It is therefore another aspect, advantage, objective and embodiment of the present invention to provide an item of memorabilia, further comprising:

indicia of association with a sponsor.

It is therefore another aspect, advantage, objective and embodiment of the present invention to provide an item of memorabilia, further comprising one member selected from the group consisting of: slogan indicia of the importance of fan support, indicia of season ticket holder status, and combinations thereof.

It is therefore another aspect, advantage, objective and embodiment of the present invention to provide an item of memorabilia, further comprising:
a holder dimensioned and configured to hold a ticket associated with the first object of fan loyalty.

It is therefore another aspect, advantage, objective and embodiment of the present invention to provide an item of memorabilia comprising:
a first identification of at least one event;
a second identification of a first object of fan loyalty involved in the at least one event;
an officially sanctioned certification of attendance at the at least one event of the first object of fan loyalty; and
indicia of the importance of the certification to the first object of the fan loyalty.

It is therefore another aspect, advantage, objective and embodiment of the present invention to provide an item of memorabilia, wherein the first object of fan loyalty further comprises: one member selected from the group consisting of: a sporting team, an individual athlete, an individual entertainer, a sporting event, an entertainment event, an athletic league, a athletic season, and combinations thereof.

It is therefore another aspect, advantage, objective and embodiment of the present invention to provide an item of memorabilia, wherein the first identification of the first object of fan loyalty further comprises: one member selected from the group consisting of: a logo of the first object of fan loyalty, a name of the first object of fan loyalty, an admission ticket to an event including the object of fan loyalty and combinations thereof.

It is therefore another aspect, advantage, objective and embodiment of the present invention to provide an item of memorabilia, wherein the officially sanctioned certification of status further comprises: a seal, a signature of an official connected with the object of the fan loyalty, and combinations thereof.

It is therefore another aspect, advantage, objective and embodiment of the present invention to provide an item of memorabilia, further comprising:

indicia of association with a charity organization.

It is therefore another aspect, advantage, objective and embodiment of the present invention to provide an item of memorabilia, further comprising:

indicia of association with a broadcast organization.

It is therefore another aspect, advantage, objective and embodiment of the present invention to provide an item of memorabilia, further comprising one member selected from the group consisting of: slogan indicia of the importance of fan support, indicia of season ticket holder status, and combinations thereof.

It is therefore another aspect, advantage, objective and embodiment of the present invention to provide an item of memorabilia further comprising:
a holder dimensioned and configured to hold a ticket associated with the first object of fan loyalty.

It is therefore another aspect, advantage, objective and embodiment of the present invention to provide a method of certifying fan loyalty comprising:

providing a certificate;

having the certificate officially certified by a first object of fan loyalty;

providing indicia identifying the first object of fan loyalty;

providing identification of at least one fan; and

providing the certificate to the fan.

It is therefore another aspect, advantage, objective and embodiment of the present invention to provide a method of certifying fan loyalty, further comprising:

charging the fan a fee for the certification of fan loyalty.

### BRIEF DESCRIPTION OF THE DRAWINGS

FIG. 1 is a front view of a first embodiment of the invention, showing small logos representing 34 NFL brand football teams and the NFL brand football league. These trademarks are property of NFL Properties Incorporated and the teams represented and are used for exemplary purposes only. The applicant is not affiliated with the NFL.

FIG. 2 is a front view of a second embodiment of the invention, showing a trademark of The Beetles brand musical group, trademark owner also not affiliated with the present applicant and the trademark is used for exemplary purposes only.

FIG. 3 is a front view of a third embodiment of the invention, showing a logo representing the New York Yankees brand baseball team and the Major League Baseball brand baseball league, which are trademarks that are the property of Major League Baseball and the teams presented.

FIG. 4 is a front view of a fourth embodiment of the invention, showing the team insignia of the Jeff Gordon automobile racing team and the NASCAR automobile racing organization, which are the property of the owners of the trademarks presented.

FIG. 5 is a front view of a fifth embodiment of the invention, showing trademarks of the National Basketball Association brand basketball league and the Detroit Pistons brand basketball team, which trademarks are the property of the National Basketball Association brand basketball league and the Detroit Pistons brand basketball team.

FIG. 6 is a front view of a sixth embodiment of the invention, showing trademarks of the Colorado Avalanche brand hockey team and the National Hockey League brand hockey league, which trademarks are owned by the Colorado Avalanche brand hockey team and the National Hockey League brand hockey league.

FIG. 7 is a front view of a seventh embodiment of the invention, showing trademarks of the Colorado Rockies brand hockey team and the National Hockey League brand hockey league and trade dress and layout of a ticket, which trademarks, trade dress and layout are trademarks owned by the Colorado Rockies brand hockey team and the National Hockey League brand hockey league.

FIG. 8 is a front view of an eighth embodiment of the invention, showing trademarks of the Arena Football League brand football league, the trademark of the Arena Bowl brand football event, the trademark owned by the Philadelphia Soul brand football team, and the trademark of the NBC/Arena Football League co-branded telecast events. This certificate depicts certification of attendance of a single championship event.

FIG. 9 is a front view of a ninth embodiment of the invention, showing trademarks of the Arena Football League brand football league, the trademark of the Arena Bowl brand football event, various trademarks owned by the Colorado Crush brand football team, and the notation “Season Ticket Holder”.

FIG. 10 is a front view of a tenth embodiment of the invention, showing trademarks of the Arena Football League brand football league, the trademark of the Arena Bowl brand football event, various trademarks owned by the Colorado Crush brand football team and the Rampage brand football team, and certification of attendance at a single non-championship sporting event.

FIG. 11 is a front view of a eleventh embodiment of the invention, showing trademarks of the National Lacrosse League brand lacrosse league, various trademarks owned by the Colorado Mammoth brand lacrosse team and the Reebok brand shoe company, and certification of fan status for a given season, as well as a sporting slogan “The 7^{th} Man”.

FIG. 12 is a front view of a twelfth embodiment of the invention, showing trademarks of the National Lacrosse League brand lacrosse league, various trademarks owned by the Colorado Mammoth brand lacrosse team and the Reebok brand shoe company, and certification of fan status for a given season, as well as a sporting slogan “The 7^{th} Man”.

FIG. 13 is a front view of a thirteenth embodiment of the invention, showing trademarks of the National Lacrosse League brand lacrosse league, various trademarks owned by the Colorado Mammoth brand lacrosse team and the Reebok brand shoe company, and certification of fan status for a given season, as well as the name of the fan.

FIG. 14 is a front view of a fourteenth embodiment of the invention, showing trademarks of the Arena Football League brand football league, the trademark of the Arena Bowl brand football event, various trademarks owned by the Colorado Crush brand football team and trademarks of various charity organizations affiliated with the league or team (such as the John Elway Heroes Foundation brand charity organization, which is not affiliated with the present applicant) as well as an indication of fan support for the team, “The 9^{th} Man”.

FIG. 15 is a front view of a fifteenth embodiment of the invention, showing trademarks of the Colorado Buffaloes brand college football team, the NCAA brand collegiate athletic league, a trademark of the FOX brand television network, an exemplary trademark of a potential sponsor of athletic events, indicia of a collegiate football league, and an indication of fan support, the “The 12′ Man.”

INDEX OF THE REFERENCE NUMERALS

| | |
|---|---|
| Certificate | 100 |
| Border | 102 |
| Seal | 104 |
| Logo | 106 |
| Alternate team insignia | 108 |
| League insignia | 110 |
| Fan identification indicia | 111 |
| Certification of fan status | 112 |
| Certificate | 200 |
| Alternate seal | 204 |
| Logo | 206 |
| Certification number | 214 |
| Date of certification | 216 |
| Signature of official | 218 |
| Certificate | 300 |
| Officiation organization | 320 |
| Certification text | 622 |
| Item of memorabilia | 624 |
| (simulated hockey puck) | |
| Certificate of fan attendance | 826 |
| Indicia of championship event | 828 |
| Certificate background pattern | 830 |
| Certificate border pattern | 832 |
| Certificate | 934 |
| Certification of Season Ticket Owning | 936 |
| Certificate | 1038 |
| Indicia of event | 1040 |
| Certificate | 1142 |
| 7^{th} Man Slogan | 1144 |
| Logo of sponsor | 1146 |
| Certificate | 1248 |
| Indicia of Venue | 1250 |
| Certificate | 1352 |
| Indicia of Fan Identification | 1354 |
| Certificate | 1456 |
| Indicia of Charity | 1458 |
| Indicia of Officially Sponsored Fan Group | 1460 |
| Slogan | 1462 |
| Certificate | 1564 |
| Logo of Educational Sponsor | 1566 |
| Logo of Network | 1568 |
| Logo of Corporate Sponsor | 1570 |

### DETAILED DESCRIPTION

Various trademarks used in the diagrams and detailed descriptions are owned by entities not having any affiliation with the applicant at the time of filing of this application.

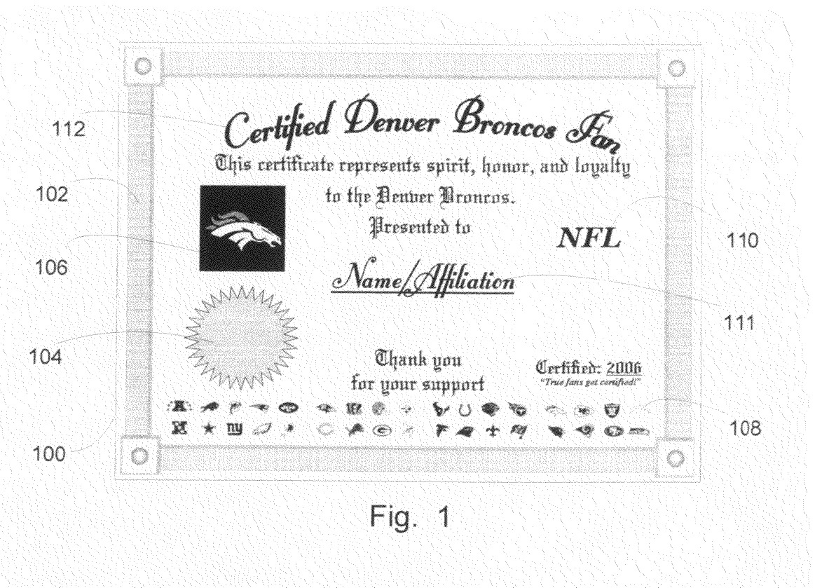

FIG. 1 is a front view of a first embodiment of the invention. Certificate 100 may be laid out in an eye-pleasing way which would allow it “blend in” with other certificates such as diplomas and licenses. For example certificate 100 may be on heavy material such as vellum or the like in addition to paper, parchment and so on. Border 102 is exemplary only, obviously other types of borders may be used. Seal 104 may be an embossed seal, a gold seal, a silver seal, ribbon and so on: in any case, the purpose of seal 104 is to show the authentic nature of the certificate, supporting the indicia identifying the certifying body.

One important possible type of seal is a notary seal of the type registered and issued by most states. In various jurisdictions, the notarial seal is only applied in the presence of the notary-public. If the notary public attends the event or location at which the certificates are to be given, then the notarial seal serves a double purpose of proving the individual fan's status but also the fan's attendance at the event. It will be appreciated that many types of events become icons of popular culture: attendance at the original rock music festivals such as that one held near Woodstock, N.Y. or early counterculture events, certain sporting events such as the NEW YORK JETS Super Bowl victory and the like are considered points of extreme pride to the true fan. (Trademarks WOODSTOCK and New York Jets are exemplary trademarks not associated with the present applicant.)

Logo 106 may, as shown, be a registered trademark (not affiliated with applicant at this time) of an object of fan loyalty such as the DENVER BRONCOS brand football team, or the logo may be another commonly applied and understood symbol. Alternate team insignia 108 may be used to indicate not loyalty but rather breadth and strength of the object of loyalty.

League insignia 110 may belong to a governing organization such as an athletic league, a recording label, a movie studio or the like to which the object of loyalty actually has ties.

In the presently preferred embodiment and best mode presently contemplated for carrying out the invention, fan identification indicia 111 may be a personalization of the item by identification of the fan such as name, seat location, a particular action taken, contact information or the like.

Certification of fan status 112 is central to the invention. The text which certifies the loyalty of the individual is exemplary only: any suitable text may be used, within the important limitation that a certification of necessity identifies itself as a certification and states the status of the certification or nature of the certification. Thus the certification of the present invention states that the fan identified is a fan certified by the body having the legal rights to use of the trademarks, logos, and other symbols, names and identifiers of the object of loyalty.

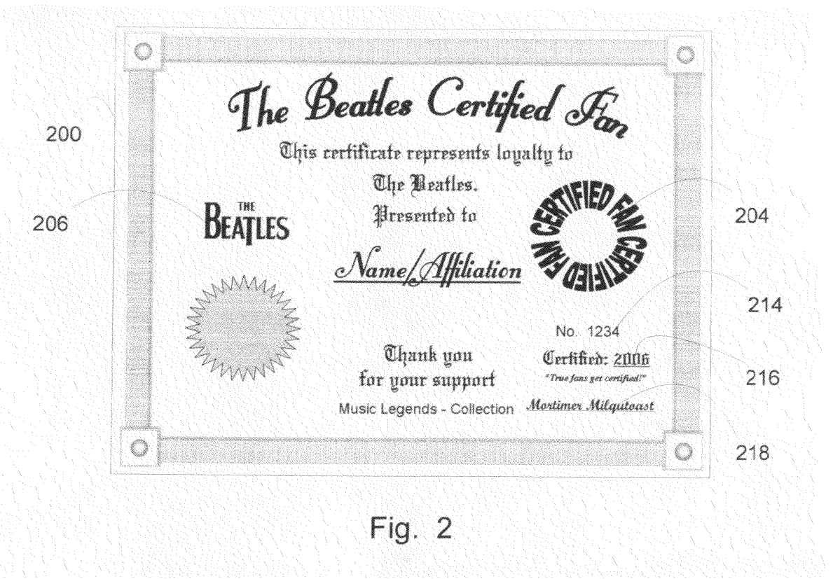

FIG. 2 is a front view of a second embodiment of the invention. It may be seen that the certificate 200 bears further indicia of the official sanction of the certification by the object of loyalty and/or its legal representatives. Alternate seal 204 and logo 206 may provide this feature, however, additional indicia of official sanction may take the form of certification number 214, the date of certification 216 and especially the signature of authorized official 218. Combined with a notarial certification (FIG. 1) this may provide a definitive item of memorabilia for the loyal fan.

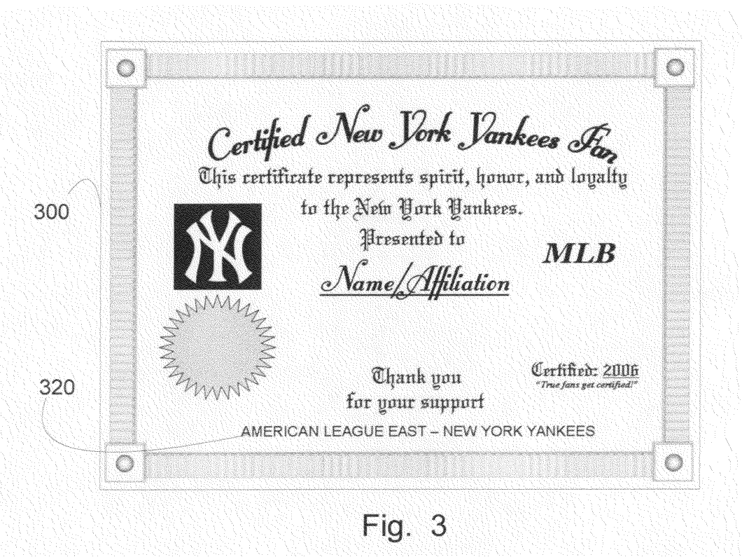

FIG. 3 is a front view of a third embodiment of the invention. Certificate 300 may bear indicia of the officiation organization 320, examples of such organizations include sports leagues, recording studios and other having rights in names and logos of the objects of fan loyalty.

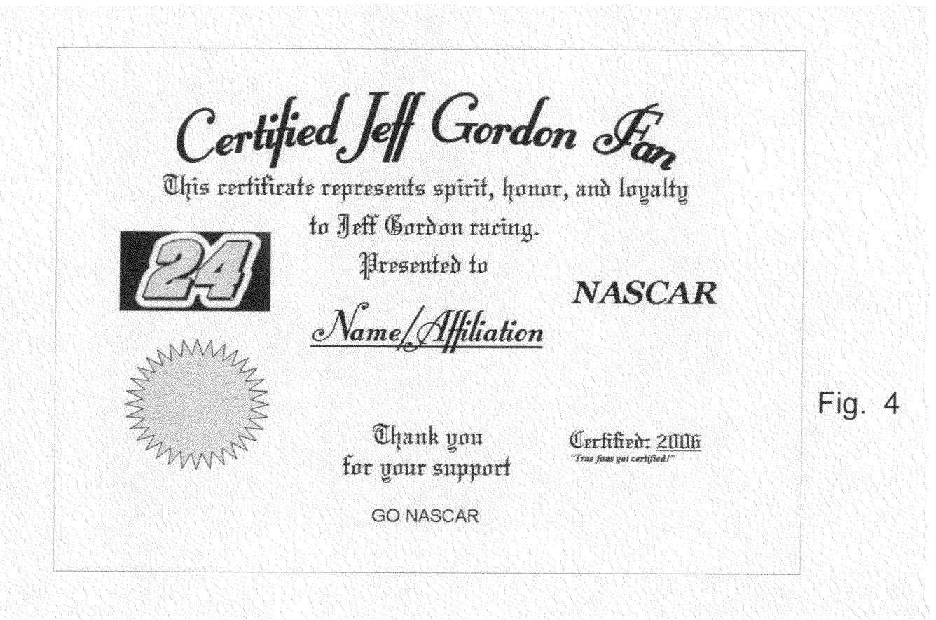

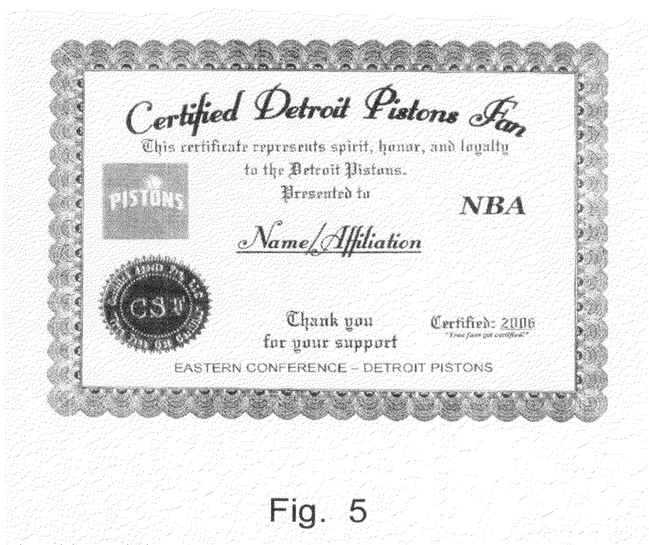

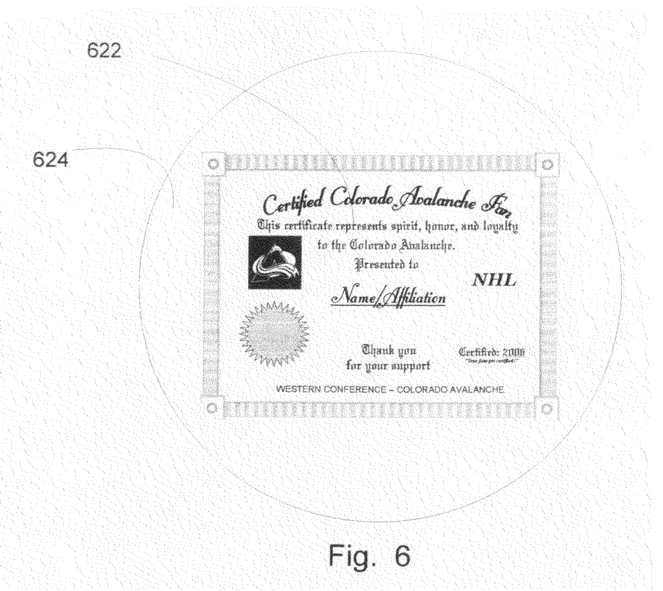

FIG. 4 is a front view of a fourth embodiment of the invention. This embodiment demonstrates that the certification may take an extremely wide variety of physical forms and appearances. This embodiment lacks a border, while in FIG. 5 (a front view of a fifth embodiment of the invention) the border is different, and in FIG. 6, which is a front view of a sixth embodiment of the invention, the entire certification text 622 is combined with a more distinctive item of memorabilia such as a gigantic simulated hockey puck 624, but which could just as easily be a baseball plate, a basketball itself and so on.

Certification text 622 may be located directly on the item of memorabilia or may be attached thereto or appended therewith.

The certification text of any embodiment may identify requirements the fan met in order to receive the certification: attendance at a particular event or series of events, other requirements or the like.

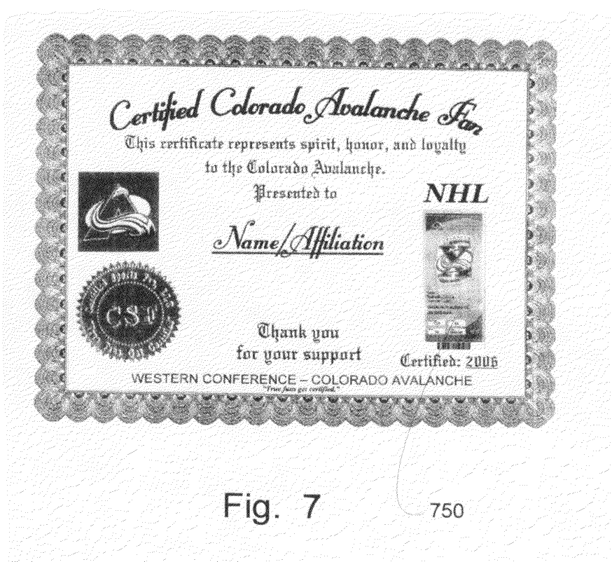

FIG. 7 is a diagram of a certificate which holds a ticket 750 or ticket stub associated with attendance at such an event.

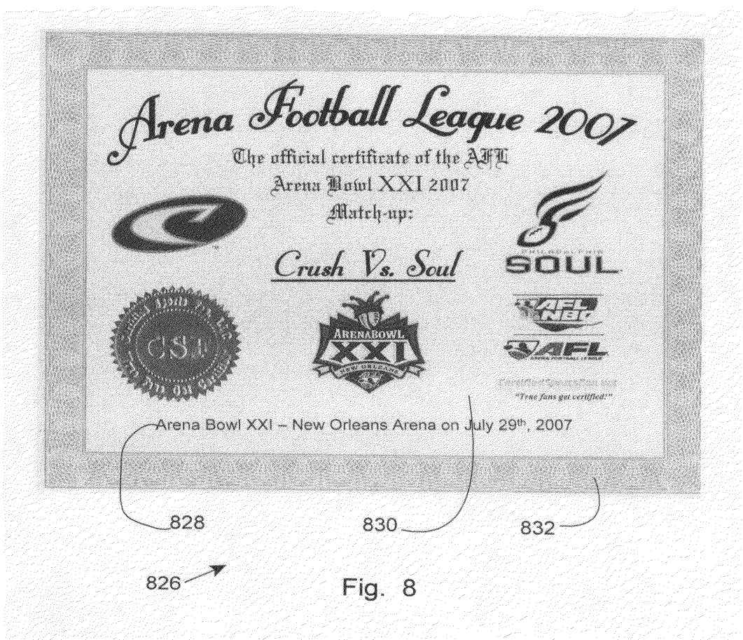

FIG. 8 is a front view of an eighth embodiment of the invention, showing trademarks of the Arena Football League brand football league, the trademark of the Arena Bowl brand football event, the trademark owned by the Philadelphia Soul brand football team, and the trademark of the NBC/Arena Football League co-branded telecast events. This certificate depicts certification of attendance of a single championship event.

Certificate of fan attendance 826 bears indicia of a championship event 828 as well as standard features of a certificate, in particular, certificate background pattern 830 (the diagram is not shaded, rather certificates frequently have background patterns such as background pattern 830), certificate border pattern 832, printing on heavy stock paper, vellum or the like, use of extravagant fonts and the like.

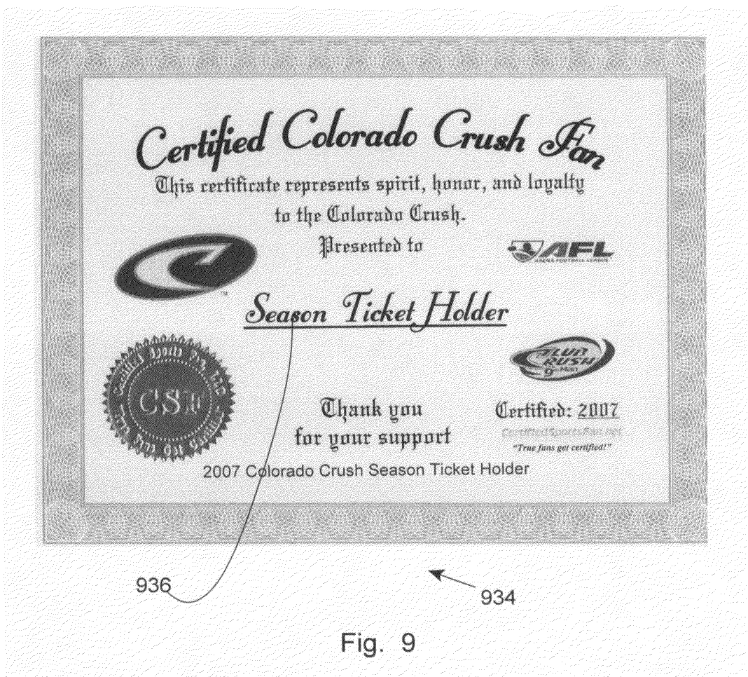

FIG. 9 is a front view of a ninth embodiment of the invention, showing trademarks of the Arena Football League brand football league, the trademark of the Arena Bowl brand football event, various trademarks owned by the Colorado Crush brand football team, and the notation “Season Ticket Holder”. Certificate 934 may be much as previously described, and the indicia of fan loyalty to the object of fan loyalty (in this example, the Colorado Crush) is certification of Season Ticket Holding 936.

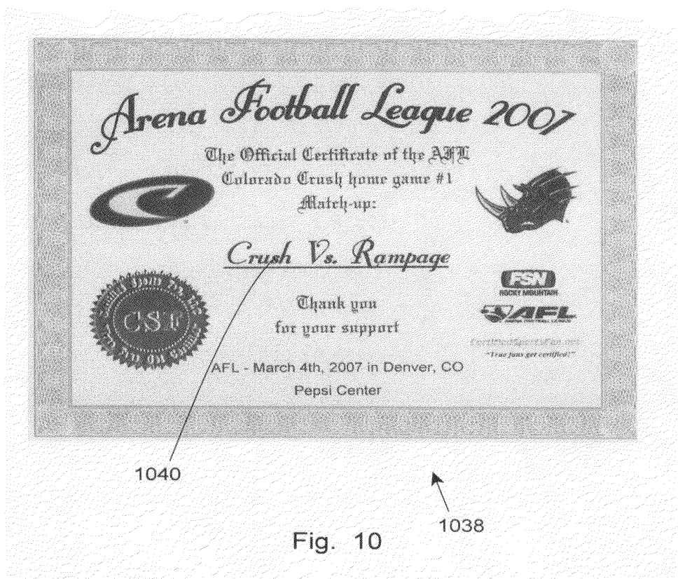

FIG. 10 is a front view of a tenth embodiment of the invention, showing trademarks of the Arena Football League brand football league, the trademark of the Arena Bowl brand football event, various trademarks owned by the Colorado Crush brand football team and the Rampage brand football team, and certification of attendance at a single non-championship sporting event.

Certificate 1038 may have indicia such as the indication of the contenders (Crush vs. Rampage) and date and venue of the event 1040.

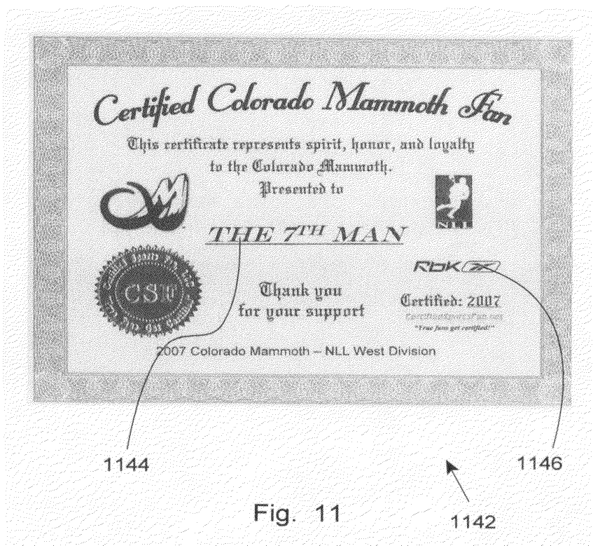

FIG. 11 is a front view of a eleventh embodiment of the invention, showing trademarks of the National Lacrosse League brand lacrosse league, various trademarks owned by the Colorado Mammoth brand lacrosse team and the Reebok brand shoe company, and certification of fan status for a given season, as well as a sporting slogan “The 7^{th} Man”.

Certificate 1142 thus includes the 7^{th} Man Slogan 1144, used to indicate that strong fan support, particularly noise, during a game, can be as beneficial as having a 7^{th} man on the field.

Logo of sponsor 1146 (the trademark of Rebook brand shoes, not affiliated with the present applicant) may indicate the commercial endorsement of the sponsor by the athletic league or team.

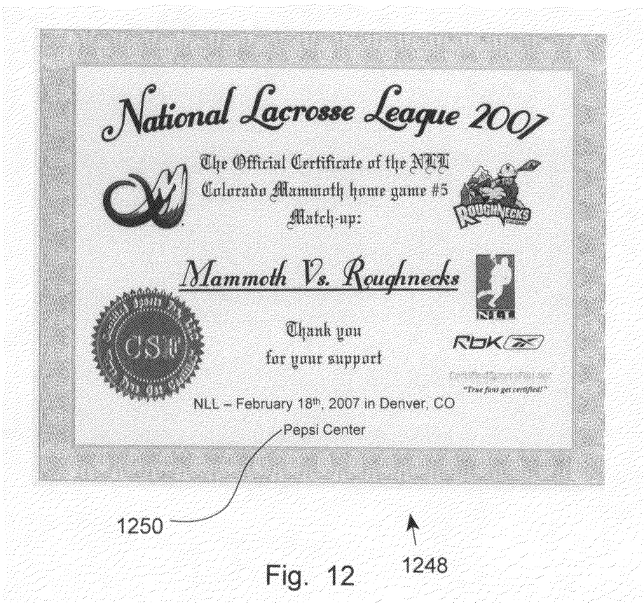

FIG. 12 is a front view of a twelfth embodiment of the invention, showing trademarks of the National Lacrosse League brand lacrosse league, various trademarks owned by the Colorado Mammoth and Roughnecks brand lacrosse teams and the Reebok brand shoe company, and certification of fan status for a given season, as well indication of the event (a game) and an indication of venue 1250 on certificate 1248.

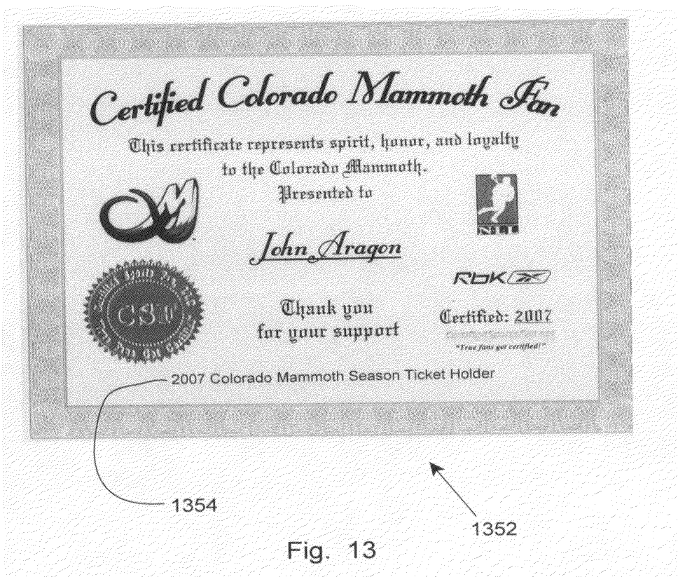

FIG. 13 is a front view of a thirteenth embodiment of the invention, showing trademarks of the National Lacrosse League brand lacrosse league, various trademarks owned by the Colorado Mammoth brand lacrosse team and the Reebok brand shoe company, and certification of fan status for a given season, as well as the name of the fan. Certificate 1352 may be seen to have a fan name serving as indicia of fan identification 1354. Note that in alternative embodiments, the identity and other certifications may be in Braille, in bar code, and so on. Note that the certification may include a seal, as discussed previously, which seal need not be printed matter but rather a gold or silver metallic device.

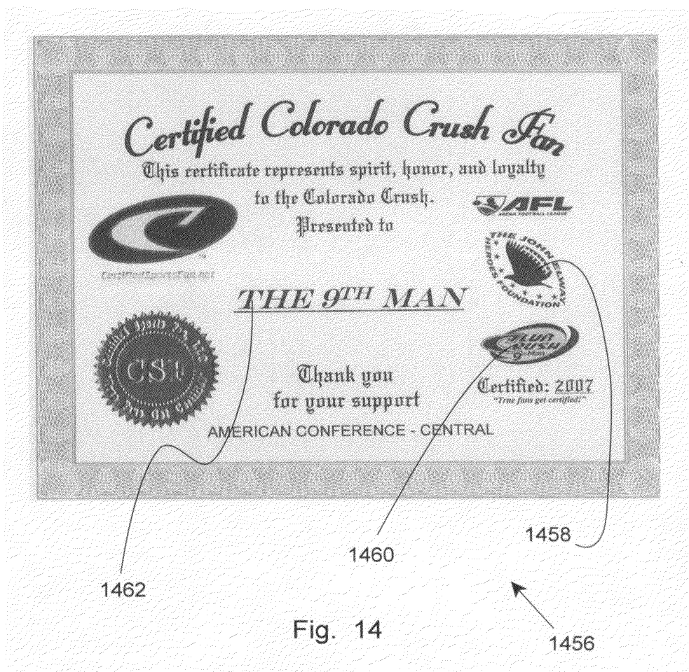

FIG. 14 is a front view of a fourteenth embodiment of the invention, showing trademarks of the Arena Football League brand football league, the trademark of the Arena Bowl brand football event, various trademarks owned by the Colorado Crush brand football team and trademarks of various charity organizations affiliated with the league or team (such as the John Elway Heroes Foundation brand charity organization, which is not affiliated with the present applicant) as well as an indication of fan support for the team, “The 9^{th} Man”.

Certificate 1456 may have indicia of charity 1458 (note that the present applicant is not affiliated with the named charity, and the trademark of the John Elway Heroes Foundation brand charity is not used with deceptive intent). Indicia of officially sponsored fan group 1460 may also be used: many athletic leagues and teams and entertainers have “official” fan groups.

Slogan 1462 may be employed as well as an indication of fan support.

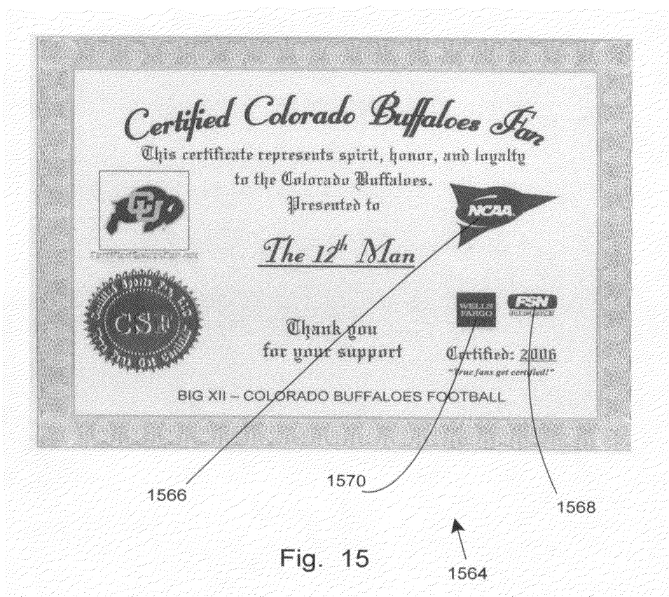

FIG. 15 is a front view of a fifteenth embodiment of the invention, showing trademarks of the Colorado Buffaloes brand college football team, the NCAA brand collegiate athletic league, a trademark of the FOX brand television network, an exemplary trademark of a potential sponsor of athletic events, indicia of a collegiate football league, and an indication of fan support, the “The 12^{th} Man.” Certificate 1564 may thus bear indicia (a logo) of educational sponsor 1566, (the NCAA brand athletic league) and/or a logo of a broadcast or other sporting or news network 1568 (Fox Sports News brand cable TV channel). Logo of corporate sponsor 1570 (Wells Fargo brand banking and financial services) may also be used, showing that numerous different trademarks of different types may be used on the same certificate. Obviously, all such marks should be used legally. In the present application, such marks are merely exemplary and no claim to the good will or any association with the owners of the marks is made.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims accompanying this patent.

I claim:

1. An item of memorabilia comprising:
a first identification of at least one fan;
a second identification of a first object of fan loyalty;
an officially sanctioned certification of the status of the at least one fan as being a fan of the first object of fan loyalty; and
indicia of the importance of the certification to the fan and object of the fan loyalty.

2. The item of memorabilia of claim 1, wherein the first identification of the individual fan further comprises: the name of the individual fan

3. The item of memorabilia of claim 1, wherein the first object of fan loyalty further comprises: one member selected from the group consisting of: a sporting team, an individual athlete, an individual entertainer, a sporting event, an entertainment event, an athletic league, a athletic season, and combinations thereof.

4. The item of memorabilia of claim 1, wherein the first identification of the first object of fan loyalty further comprises: one member selected from the group consisting of: a logo of the first object of fan loyalty, a name of the first object of fan loyalty, an admission ticket to an event including the object of fan loyalty and combinations thereof.

5. The item of memorabilia of claim 1, wherein the officially sanctioned certification of status further comprises: a seal, a signature of an official connected with the object of the fan loyalty, and combinations thereof.

6. The item of memorabilia of claim 1, further comprising:
indicia of association with a charity organization.

7. The item of memorabilia of claim 1, further comprising:
indicia of association with a sponsor.

8. The item of memorabilia of claim 1, further comprising one member selected from the group consisting of: slogan indicia of the importance of fan support, indicia of season ticket holder status, and combinations thereof.

9. The item of memorabilia of claim 1, further comprising:
a holder dimensioned and configured to hold a ticket associated with the first object of fan loyalty.

10. An item of memorabilia comprising:
a first identification of at least one event;
a second identification of a first object of fan loyalty involved in the at least one event;
an officially sanctioned certification of attendance at the at least one event of the first object of fan loyalty; and
indicia of the importance of the certification to the first object of the fan loyalty.

11. The item of memorabilia of claim 10, wherein the first object of fan loyalty further comprises: one member selected from the group consisting of: a sporting team, an individual athlete, an individual entertainer, a sporting event, an entertainment event, an athletic league, a athletic season, and combinations thereof.

12. The item of memorabilia of claim 10, wherein the first identification of the first object of fan loyalty further comprises: one member selected from the group consisting of: a logo of the first object of fan loyalty, a name of the first object of fan loyalty, an admission ticket to an event including the object of fan loyalty and combinations thereof.

13. The item of memorabilia of claim 10, wherein the officially sanctioned certification of status further comprises: a seal, a signature of an official connected with the object of the fan loyalty, and combinations thereof.

14. The item of memorabilia of claim 10, further comprising:
indicia of association with a charity organization.

15. The item of memorabilia of claim 10, further comprising:
indicia of association with a broadcast organization.

16. The item of memorabilia of claim 10, further comprising one member selected from the group consisting of: slogan indicia of the importance of fan support, indicia of season ticket holder status, and combinations thereof.

17. The item of memorabilia of claim 10, further comprising:
a holder dimensioned and configured to hold a ticket associated with the first object of fan loyalty.

18. A method of certifying fan loyalty comprising:
providing a certificate;
having the certificate officially certified by a first object of fan loyalty;
providing indicia identifying the first object of fan loyalty;
providing identification of at least one fan; and
providing the certificate to the fan.

19. The method of claim 18, further comprising:
charging the fan a fee for the certification of fan loyalty.
